(19) United States
(12) Patent Application Publication
(10) Pub. No.: US 2018/0156275 A1
(43) Pub. Date: Jun. 7, 2018

(54) METHOD FOR PRODUCING ROLLING BEARING RINGS AND ROLLING BEARING

(71) Applicant: SCHAEFFLER TECHNOLOGIES AG & CO. KG, Herzogenaurach (DE)

(72) Inventors: Oskar BEER, Landshut (DE); Jens FELLA, Gochsheim (DE)

(73) Assignee: Schaeffler Technologies AG & Co. KG, Herzogenaurach (DE)

(21) Appl. No.: 15/569,959

(22) PCT Filed: Apr. 25, 2016
(86) PCT No.: PCT/DE2016/200195

§ 371 Date: Oct. 27, 2017

(30) Foreign Application Priority Data
Apr. 28, 2015 (DE) 10 2015 207 779.9

(51) Int. Cl. F16C 33/64; B21D 53/10

(52) U.S. Cl. CPC F16C 33/64; B21D 53/10

(57) ABSTRACT

The disclosure relates to methods for treating rolling bearing rings, for example, to introduce a high hardness and long service life. In one method, rolling bearing rings may be cold-hardened by applying residual compressive stresses mechanically in the region of the race. Material may then be removed from the race surface. The disclosure furthermore relates to rolling bearings having rolling bearing rings produced in this way.

### CROSS-REFERENCE TO RELATED APPLICATIONS

This application is the U.S. National Phase of PCT Appln. No. PCT/DE2016/200195 filed Apr. 25, 2016, which claims priority to DE 102015207779.9 filed Apr. 28, 2015, the entire disclosures of which are incorporated by reference herein.

### TECHNICAL FIELD

The disclosure relates to a method for treating rolling bearing rings to provide a high hardness and long service life. In this method, rolling bearing rings are cold-hardened by applying residual compressive stresses mechanically in the region of the race. The disclosure furthermore relates to rolling bearings having rolling bearing rings produced in this way.

### BACKGROUND

The prior art includes the introduction of residual compressive stresses into surfaces by shot peening. However, the residual compressive stress profile produced in this way has proven to have only limited suitability for the races of bearing rings. Among the disadvantages of introducing residual compressive stresses by shot peening is the shallow depth of the residual stresses introduced in this way of just a few tenths of a millimeter and the necessity of having to interrupt production for this purpose in order to treat each component separately. This means not only a loss of time due to any work that may be contracted out but also, in particular, an increase in costs.

Residual compressive stresses in balls which are introduced by means of barreling or by means of “laser shot peening” as a mechanical “dynamic” penetration method increase the degree of plastic deformation of rolling elements treated in this way and can enhance the service life thereof. However, such methods are not suitable for bearing rings owing to the geometry or, in the case of “laser shot peening” are at least too complex and therefore too expensive.

EP 2 759 729 A1 describes a method for producing a rolling bearing in which residual compressive stresses in the boundary layer are formed in the inner ring by cold hardening in the region of the race. In the best case, subsequent removal of material by grinding is stated to be required to a small degree.

Also known is a cold hardening process by means of a tool, in which the region of material close to the surface is continuously plastically deformed by rolling profiled rollers or rolls one or more times over said region under defined contact forces. This procedure is also referred to as deep rolling. A deep rolling tool made by Ecoroll AG, for example, is known for this purpose. A suitable tool comprises at least one rolling element (e.g. a ceramic ball), which is hydrostatically supported. This hydrostatic design is decisive for the service life of the rolling element. The tool is preferably designed in such a way that it can be used both in conventional and in CNC machines.

Hitherto, the aim of such cold hardening has been to counteract the formation and growth of a crack under bending/alternating loads. Here, the cold hardening process on the relevant components is provided as a finishing treatment. Subsequent finishing/finish grinding designed specifically to determine the depth of the maximum stress is not known.

Admittedly, the tool made by Ecoroll AG, for example, and hence a form of the deep rolling process are already known from the prior art. However, it is only possible to process components with a simple geometry by this method. Treatment of bearing rings in accordance with the method according to the disclosure has not hitherto been envisaged since the advantages and interrelationships in this method, which will be described below, with the material characteristics and specific material loads in the case of bearing rings—especially as a function of the depth of the maximum of the residual compressive stress introduced—were not known.

Owing to the continuously increasing demands on engine bearings, e.g. higher loads, longer service life, higher bearing reliability and a higher speed index, the rolling bearing material is subject to ever greater loads. The speed index (n×dm) is a measure of the peripheral speed in the bearing, wherein n denotes the speed in [rpm] and dm denotes the pitch diameter in [mm]. The higher this value, the better the design and selection of materials for the bearing must be harmonized.

### SUMMARY

It is therefore an object of the disclosure to indicate a mechanical production method which can be integrated easily into the production process and by means of which the performance of rolling bearing steels, specifically for (rolling) bearing rings, can be enhanced. At the same time, a positive effect should be exerted on the material, both in respect of the service life and also of failure progression when compared with the prior art.

This object may be achieved by methods disclosed herein. In one example, residual compressive stresses are introduced selectively in a mechanical manner into the material of bearing rings, and the potential of the material is thus exploited in an effective manner. This is because the overall stress level of the equivalent stress during operation is reduced by the mechanical residual compressive stresses introduced, and thus both the service life and performance of the bearing or of the bearing ring treated in this way are enhanced.

The equivalent stress is taken to mean a measure of the material stress in a multi-axis stress condition. In this connection, the “shear stress hypothesis” of Tresca will be referred to below by way of example as an explanation:

### BRIEF DESCRIPTION OF THE DRAWINGS

FIG. 1 shows the characteristic of the stresses under the contact center for a circular contact surface (sphere-plane), where p0 stands for the Hertzian pressure. The z direction is directed inward into the material, while the x and y directions are parallel to the surface.

### DETAILED DESCRIPTION

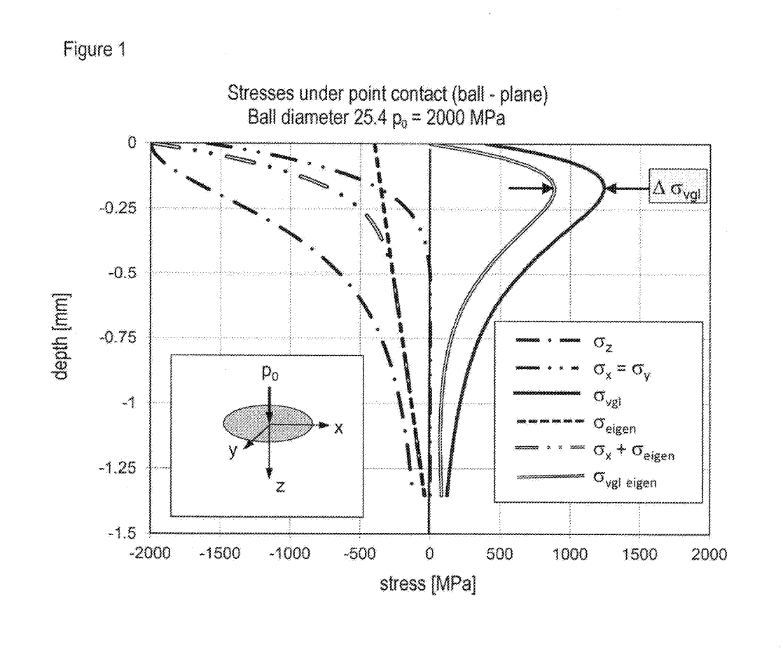

The characteristic of the principal stress σz (z direction) is shown as a dash-dotted line in the left-hand half of FIG. 1, while the characteristic of the principal stresses σx=σy (in the x and y directions since both stresses are equal because of the axial symmetry of contact) is shown as a dash-dot-dot line. According to Tresca, the difference between stresses σz and σx (maximum and minimum principal stress) corresponds to the material stress σvgl shown as a solid line on the right in the diagram. Typically for Hertzian contact, the maximum is below the surface.

It is assumed that residual stresses act only in the x and y directions, this being not only confirmed by measurements but also being explained in respect of the surface itself by reasons of equilibrium. The residual stresses σeigen are shown as a straight dashed line in the left-hand half of the diagram. These residual stresses are then superimposed on the load stresses σx and σy, leading to their being shifted in the direction of σz (illustrated in the left-hand half of the diagram as an open dash-dot-dot line). Thus, the distance between the stress σz and the stresses σx and σy on which the residual stresses are superimposed becomes smaller, and therefore the equivalent stress also decreases (illustrated as a thick continuous line in the right-hand half of the diagram, the maximum reduction in the equivalent stress being shown as Δσ_{vgl}).

Similar results are also obtained in consideration of the distortion energy hypothesis of v. Mises.

Building on these insights, the treatment or production method according to the disclosure comprises the following steps:

First of all, the bearing rings (inner and/or outer rings) are produced, e.g. forged or turned, and then hardened. This may be followed by grinding of the bearing rings to a predetermined “rough grinding dimension”.

This may be followed by cold hardening of the surfaces of the bearing rings by means of a continuous plastic deformation process. By means of this cold deformation process, a defined residual compressive stress condition is produced in the region of the race in order, as explained above, to superimpose the load stress. The most important parameters in the defined introduction process are the rolling force, feed rate and rolling ball diameter of the tool. The residual compressive stress produced in this way has superimposed upon it during operation the rolling stress resulting from the Hertzian pressure and leads overall to a lower total stress level. In this way, the service life may be increased and possible failure progression may be reduced.

There then follows finish machining in accordance with the insight that the diameter of the roll and the contact pressure thereof have an effect on the depth of the maximum residual compressive stress and these, in turn, require combination with a specifically determined removal of material by grinding in order to significantly increase the rolling contact strength and improve the failure progression behavior.

For this purpose, a surface layer is removed, the thickness of which is typically greater than the depth of the maximum residual compressive stress introduced.

The bearing rings produced in this way may then be tested on a case-by-case basis.

The production method according to the disclosure may have several advantages: there are no high acquisition costs entailed by additional machines. The depth of the maximum residual compressive stress can be set through an appropriate choice of rolling ball diameter. For a deep rolling process of relatively short duration, this method step produces easily reproducible results. Another positive effect consists in that the roughness values are additionally improved.

In comparison with other production methods, e.g. ball peening, which could also be used to introduce residual compressive stresses, the methods according to the disclosure are distinguished by the residual compressive stress profile produced. In the deep rolling process, the maximum of the residual compressive stress is deeper below the workpiece surface than in the ball peening process. In the ball peening process, the maximum depth of the maximum residual compressive stresses is at about 50 to 100 μm below the surface. In contrast, the depth of the maximum residual compressive stress of components which have been deep-rolled is several tenths of a millimeter, which is advantageous for use in the rolling bearing sector.

In one illustrative embodiment, a ball composed of a ceramic (in this case: Si₃N₄) is used. It is pressed onto the workpiece surface with the (hydraulic) pressure pp. Because of the pressure per unit area which occurs in the contact zone in the regions of the workpiece to be machined which are close to the surface, the three-axis stress condition explained above is established. The magnitudes of the principal stresses which occur are dependent on the contact pressure and on the ball diameter DW. As soon as the equivalent stress at the rolling contact exceeds the elastic limit of the workpiece, local plastic deformations and thus residual compressive stresses occur. The depth of the maximum resulting residual compressive stress will correspond approximately to the depth of the maximum equivalent stress since the greatest plastic deformation takes place at this location.

Here, the rolling diameter has an effect on the depth of the maximum residual compressive stress and this is given by the following equation:

$${t}_{ES , 0} = {D}_{W} \cdot ( \frac{{t}_{ES , max}}{{D}_{W}} + \frac{{Δσ}_{vgl}}{{p}_{0} \cdot 6.744} )$$

In this example, the maximum depth of the residual compressive stress is 150 μm.

1. A method for producing a rolling bearing ring, comprising:
producing a bearing ring;
hardening the bearing ring;
grinding the bearing ring to a predetermined rough grinding dimension;
rolling a race of the bearing ring using a rolling element with a predetermined rolling force, feed rate, and diameter; and
removing material from a rolled surface of the race with a layer thickness which is greater than a depth of a maximum residual compressive stress introduced by the rolling.

2. A rolling bearing comprising at least one rolling bearing ring, which is produced by the method of claim 1.

3. The method of claim 1, wherein the rolling element is a ball.

4. The method of claim 3, wherein the ball is a ceramic.

5. The method of claim 4, wherein the ball is formed of Si₃N₄.

6. The method of claim 1, wherein the rolling element is pressed into the race using hydraulic pressure.

7. A method of hardening a bearing ring, comprising:
rolling a race of a bearing ring using a rolling element to introduce a maximum residual compressive stress at a certain depth, the rolling being performed using a predetermined rolling force, feed rate, and rolling element diameter; and
removing material from a rolled surface of the race, wherein a removed layer thickness is greater than the depth of the maximum residual compressive stress introduced by the rolling.

8. A rolling bearing comprising at least one rolling bearing ring, which is produced by the method as claimed in claim 7.

9. The method of claim 7, wherein the rolling element is a ball.

10. The method of claim 9, wherein the ball is a ceramic.

11. The method of claim 10, wherein the ball is formed of Si₃N₄.

12. The method of claim 7, wherein the rolling element is pressed into the race using hydraulic pressure.

13. The method of claim 7, wherein rolling the race introduces a maximum equivalent stress at a depth that corresponds to the depth of the maximum residual compressive stress.
